(19) United States
(12) Patent Application Publication
(10) Pub. No.: US 2008/0220225 A1
(43) Pub. Date: Sep. 11, 2008

(54) Filter and display apparatus including the same

(76) Inventors: Dong-Gun Moon, Suwon-si (KR); Jae-Woo Bae, Suwon-si (KR); Jun-Kyu Cha, Suwon-si (KR); Sang-Yeol Hur, Suwon-si (KR); Hee-Seong Jeong, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/073,629

(22) Filed: Mar. 7, 2008

(30) Foreign Application Priority Data
Mar. 8, 2007 (KR) 10-2007-0023174

(51) Int. Cl. B32B 3/10

(52) U.S. Cl. 428/195.1

(57) ABSTRACT

A filter includes a base film having a first surface and a second surface, and a plurality of first color patterns on the first surface of the base film, the first color patterns having a stripe pattern with first predetermined intervals therebetween.

### BACKGROUND OF THE INVENTION

1. Field of the Invention

Embodiments of the present invention relate to a filter and a display apparatus including the same. More particularly, embodiments of the present invention relate to a lightweight filter providing excellent bright room contrast and to a display apparatus including the same.

2. Description of the Related Art

A conventional display apparatus may include a filter for the purpose of, e.g., adjusting color, shielding electromagnetic radiation emitted from the display apparatus, preventing reflection of external light, and so forth. For example, a conventional plasma display apparatus may include a plasma display panel with a filter thereon in order to minimize electromagnetic radiation and reflection of external light.

The conventional filter may be a tempered glass filter including a plurality of functional films with adhesive layers therebetween. More specifically, the conventional filter may include an anti-reflective layer, a heat-treated tempered glass layer, an etching mesh film, and a near infrared-absorbing film sequentially stacked on top of each other with an adhesive layer between every two functional films. Accordingly, the conventional filter may include four functional films with four adhesive layers therebetween.

The large number of layers in the conventional filter, however, may provide a relatively heavy filter with a complex structure, so manufacturing processes may be complicated and production costs may be increased. Further, a large number of layers in the conventional filter may cause a double-image reflection between the filter and the display device. Additionally, the conventional filter may cause either a reduced bright room contrast or a reduced brightness with respect to an increase in bright room contrast.

### SUMMARY OF THE INVENTION

Embodiments of the present invention are therefore directed to a filter and a display apparatus including the same, which substantially overcome one or more of the disadvantages and shortcomings of the related art.

It is therefore a feature of an embodiment of the present invention to provide a filter having reduced weight and low manufacturing costs.

It is therefore another feature of an embodiment of the present invention to provide a filter capable of transmitting internal light, while minimizing reflection of external light.

It is yet another feature of an embodiment of the present invention to provide a filter capable of increasing both brightness and bright room contrast.

It is still another feature of an embodiment of the present invention to provide a display apparatus including a filter having one or more of the above features.

At least one of the above and other features and advantages of the present invention may be realized by providing a filter, including a base film having a first surface and a second surface, and a plurality of first color patterns on the first surface of the base film, the first color patterns having a stripe pattern with first predetermined intervals therebetween. Widths of the first color patterns and widths of the first predetermined intervals therebetween may be related according to w≦d≦95w, where w denotes a width of a single color pattern of the plurality of first color patterns and d denotes a width of a single interval between two adjacent first color patterns. A width of a single color pattern of the plurality of first color patterns may be about 5 μm to about 50 μm. A thickness of the first color patterns may be about 1 μm to about 200 μm. A ratio of the thickness to the width of the first color patterns may be about 0.025 to about 50. The filter may further include an adhesive layer on a second surface of the base film. The base film may include dyes and/or pigments.

The filter may further include a plurality of second color patterns on the second surface of the base film, the second surface being opposite the first surface. The second color patterns may have a stripe pattern with second predetermined intervals therebetween. The second color patterns may overlap with the first color patterns. The first color patterns may overlap at least about 80% of the second color patterns. The first and second color patterns may completely overlap each other. Widths of the first and second color patterns and widths of the first and second predetermined intervals therebetween, respectively, may be related according to w≦d≦95w, where w denotes a width of a single first or second color pattern and d denotes a width of a single interval between two adjacent first or second color patterns. Widths of the first color patterns may substantially equal widths of the second color patterns. The filter may further include an adhesive layer on the second surface of the base film, the adhesive layer being in the second intervals between the second color patterns. A width of each of the first and second color patterns may be about 5 μm to about 60 μm. A thickness of each of the first and second color patterns may be about 1 μm to about 200 μm. A ratio of the thickness to the width of each of the first and second color patterns may be about 0.025 to about 60.

At least one of the above and other features and advantages of the present invention may be also realized by providing a display apparatus, including a display panel configured to display images, an operation circuit configured to electrically control the display panel, a chassis between the display panel and the operation circuit, and a filter attached to a front surface of the display panel, wherein the filter includes a base film having a first surface and a second surface, and a plurality of first color patterns on the first surface of the base film, the first color patterns having a stripe pattern with first predetermined intervals therebetween. The display apparatus may be a plasma display apparatus.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic partial cross-sectional view of a filter according to an embodiment of the present invention;

FIG. 2 illustrates a schematic partial cross-sectional view of a filter according to another embodiment of the present invention;

FIG. 3 illustrates an exploded perspective view of a plasma display apparatus with a filter according to an embodiment of the present invention; and

FIG. 4 illustrates a cross-sectional view along line V-V of FIG. 3.

### DETAILED DESCRIPTION OF THE INVENTION

Korean Patent Application No. 10-2007-0023174, filed on Mar. 8, 2007, in the Korean Intellectual Property Office, and entitled: “Filter and Display Apparatus Including the Same,” is incorporated by reference herein in its entirety.

Embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

FIG. 1 illustrates a partial cross-sectional view of a filter of a display apparatus according to an embodiment of the present invention. As illustrated in FIG. 1, a filter 10 may include a plurality of color patterns 11 and a base film 13. The filter 10 may be attached to a screen (not shown) of a display apparatus (not shown) via the base film 13.

The color patterns 11 may be disposed in a stripe pattern on a first surface of the base film 13, so two adjacent color patterns 11 may have a predetermined interval d1 therebetween, i.e., a distance as measured along the x-axis. The predetermined intervals d1 between the color patterns 11 may be constant, so light reflection from the filter 10 may be reduced uniformly across the entire screen of the display apparatus. The color patterns 11 may be formed of a material having a high absorption rate with respect to visible light, and may have an opaque color, e.g., the color patterns 11 may be black. The color patterns 11 may extend along the z-axis, and may have a thickness t1, i.e., a distance as measured along the y-axis. Each color pattern 11 may have a width w1, i.e., a distance as measured along the x-axis.

A relationship between widths w1 and the predetermined interval d1 therebetween may be w1≦d1≦95w1. When the width w1 of each of the color patterns 11 substantially equals a width of a single predetermined interval d1, a sum of all the intervals d1 between the color patterns 11 may substantially equal about 50% of a width of the screen of the display apparatus, i.e., an aperture rate of about 50%. When the width w1 is larger than the interval d1, i.e., the aperture rate is less than about 50%, light transmissivity rate of the filter 10 may be lowered, which in turn, may decrease brightness of the display apparatus. When the predetermined interval d1 is larger than 95 times the width w1, i.e., an aperture rate above about 95%, an external light reflection of the filter 10 may be substantially increased, which in turn, may decrease bright room contrast of the display apparatus.

The width w1 of each color pattern 11 may be about 5 μm to about 50 μm, and the thickness t1 of each color pattern 11 may be about 1 μm to about 200 μm. The width w1 may be about 0.025 to about 50 times larger than the thickness t1. When the thickness t1 of the color patterns 11 is greater than about 200 μm, the viewing angle of the display apparatus may be substantially reduced. When the thickness t1 of the color patterns 11 is lower than about 1 μm, bright room contrast of the display apparatus may be reduced, e.g., bright room contrast improvement according to an embodiment of the present invention may be offset.

The base film 13 of the filter 10 may be formed of any suitable transparent material, and may exhibit adhesive properties, e.g., a material having proper interface characteristics to easily and tightly attach to glass and/or plastic. The base film 13 may be formed of a flexible material to facilitate transportation and attachment to the display apparatus. A second surface of the base film 13, i.e., a surface opposite the first surface, may be attached to the display apparatus, so the base film may be between the color patterns 11 and the display apparatus. The base film 13 may bond the filter 10 directly to a front surface of the display apparatus. Alternatively, the base film 13 may bond the filter 10 to the front surface of the display apparatus via an adhesive layer 15, i.e., the adhesive layer 15 may be applied between the second surface of the base film and the front surface of the display apparatus, as will be described in more detail below. If the adhesive layer 15 is used, as illustrated in FIG. 1, the interface characteristics of the base film 13 with respect to glass and/or plastic may be less relevant. The base film 13 may be formed of, e.g., one or more of polyethersulphone (PES), polyacrylate (PAR), polyetherimide (PEI), polyethylene naphthalate (PEN), polyethylene terephthalate (PET), polyphenylene sulfide (PPS), polyallylate, polyimide, polycarbonate (PC), cellulose triacetate (TAC), cellulose acetate propionate (CAP), or the like. For example, the base film 13 may be formed of PC, PET, TAC, and/or PEN.

The base film 13 may be colored with a predetermined color in any suitable way to adjust transmissivity of light and to provide color correction. Accordingly, the base film 13 may include any suitable coloring agent, e.g., dye and/or pigment. Examples of suitable coloring agents may include one or more of a cyanine-compound, a squarylium-compound, an azomethine-compound, a xanthene-compound, an oxonol-compound, and/or an azo-compound. For example, transmissivity of visible light through the filter 10 may be adjusted by controlling color of the base film 13, e.g., the base film 13 may have a dark color to decrease transmissivity of visible light therethrough. In another example, a color of visible light emitted from the display apparatus through the filter 10 may be controlled, e.g., the base film 13 may be colored to improve color purity exhibited by the display apparatus. In yet another example, the base film 13 may have color patterns corresponding to respective sub pixels of the display apparatus.

The base film 13 may be a flexible panel, and may have a thickness of about 50 μm to about 500 μm, e.g., a thickness of about 80 μm to about 400 μm. When the base film 13 is too thin, the base film 13 may not be capable of minimizing scattering of pieces upon breakage of the display apparatus. When the base film 13 is too thick, efficiency of laminating the base film 13 may be decreased.

The adhesive layer 15 of the filter 10 may be any suitable adhesive, e.g., pressure sensitive adhesive (PSA), and may include a thermoplastic resin and/or a ultraviolet (UV) thermosetting resin. For example, the adhesive layer 15 may include an acryl resin. Since the adhesive layer 15 may directly contact the front surface of the display apparatus, refraction rates of the adhesive layer 15 and the display apparatus may be easily adjusted to a predetermined value, e.g., about 1.0% or less, in order to decrease double-image reflection. The adhesive layer 15 may be formed by, e.g., dip coating, air knife coating, roller coating, wire bar coating, gravure coating, and so forth.

The adhesive layer 15 may further include an additive, e.g., one or more of a near infrared (IR) light absorbing agent, a coloring agent for blocking neon light or correcting colors, and so forth. Examples of near IR light absorbing agents may include one or more of a copper-containing resin, a phosphor-containing resin, a sulfur-containing resin, a tungsten-containing resin, and/or a cyanine-containing resin. Examples of coloring agents, i.e., a dye and/or a pigment, may include compounds capable of selectively absorbing visible light, i.e., light having a wavelength of about 400 nm to about 700 nm. For example, if the display apparatus, e.g., plasma display apparatus, includes a discharge gas, e.g., neon gas and/or xenon gas, generating visible light having a wavelength of about 585 nm, the coloring agent may be a cyanine-compound, a squarylium-compound, an azomethine-compound, a xanthene-compound, an oxonol-compound, and/or an azo-compound. The coloring agent may be present in the adhesive layer 15 in a dispersed micro particle form.

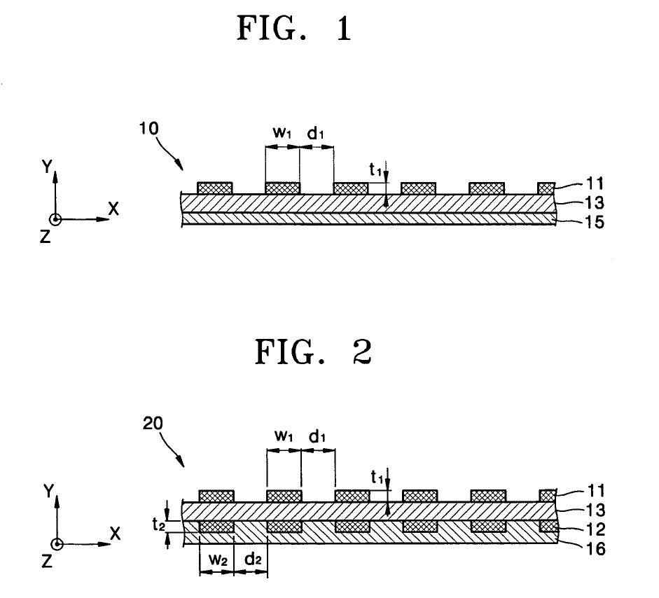

According to another embodiment illustrated in FIG. 2, a filter 20 may be substantially similar to the filter 10 described previously with reference to FIG. 1, with the exception of including color patterns on the first and second surfaces of the base film 13. More specifically, as illustrated in FIG. 2, the filter 20 may include the color patterns 11 on the first surface of the base film 13, as described previously with reference to FIG. 1. Additionally, the filter 20 may include color patterns 12 on the second surface of the base film 13. The color patterns 11 were described previously, and therefore, their detailed description will not be repeated.

The color patterns 12 may be disposed in a stripe pattern on the second surface of the base film 13, i.e., a surface opposite the first surface, so two adjacent color patterns 12 may have a predetermined interval d2 therebetween, i.e., a distance as measured along the x-axis. The predetermined intervals d2 between the color patterns 12 may be constant, so light reflection from the filter may be reduced uniformly across the entire screen of the display apparatus. The color patterns 12 may be formed of a material having a high absorption rate with respect to visible light, and may have an opaque color, e.g., the color patterns 12 may be black. The color patterns 12 may extend along the z-axis, and may have a thickness t2, i.e., a distance as measured along the y-axis. Each color pattern 12 may have a width w2, i.e., a distance as measured along the x-axis.

A relationship between the width w2 and the predetermined interval d2 of the color patterns 12 may be w2≦d2≦95w2. When the width w2 is larger than the interval d2, the light transmissivity rate of the filter 20 may be lowered, which in turn, may decrease brightness of the display apparatus. When the predetermined interval d2 is larger than 95 times the width w2, an external light reflection of the filter 20 may be substantially increased, which in turn, may decrease bright room contrast of the display apparatus 20. The width w1 of the color patterns 11 may substantially equal the width w2 of the color patterns 12, the intervals d1 of the color patterns 11 may substantially equal the intervals d2 of the color patterns 12, and the thickness t1 of the color patterns 11 may substantially equal the thickness t2 of the color patterns 12. For example, the widths w1 and w2 may be substantially equal, and may range from about 5 μm to about 60 μm. On the other hand, the widths, thicknesses, and/or intervals of the color patterns 11 may be different from the widths, thicknesses, and intervals of the color patterns 12.

The color patterns 11 may be disposed to substantially overlap with the color patterns 12, so each color pattern 11 may correspond to and overlap with a respective color pattern 12 on an opposite surface of the base film 13. The color patterns 11 may completely or partially overlap with the color patterns 12. If the color patterns 11 overlap only partially with the color patterns 12, the color patterns 11 may be misaligned with the color patterns 12 to an extent of less than about 20%. In other words, if the color patterns 11 are misaligned with respect to the color patterns 12, at least about 80% of the widths w1 of the color patterns 11 and width w2 of the color patterns 12 may overlap. A complete overlap between the color patterns 11 and the color patterns 12 may correspond to about 0% misalignment. When the misalignment is about 20% or more, the aperture rate of the filter 20 may be reduced, so light transmittances may be decreased and external light reflection may be increased.

The base film 13 with the color patterns 11 and the color patterns 12 may be bonded to the front surface of the display apparatus via an adhesive layer 16, as illustrated in FIG. 2. The adhesive layer 16 may be substantially similar to the adhesive layer 15 described previously with reference to FIG. 1, with the exception of being applied to the second surface of the base film 13 and the color patterns 12. More specifically, the adhesive layer 16 may coat the color patterns 12, so spaces between the color patterns 12 may be completely filled therewith. The adhesive layer 16 may coat outer surfaces of the color pattern 12, i.e., surfaces facing away from the base film 13.

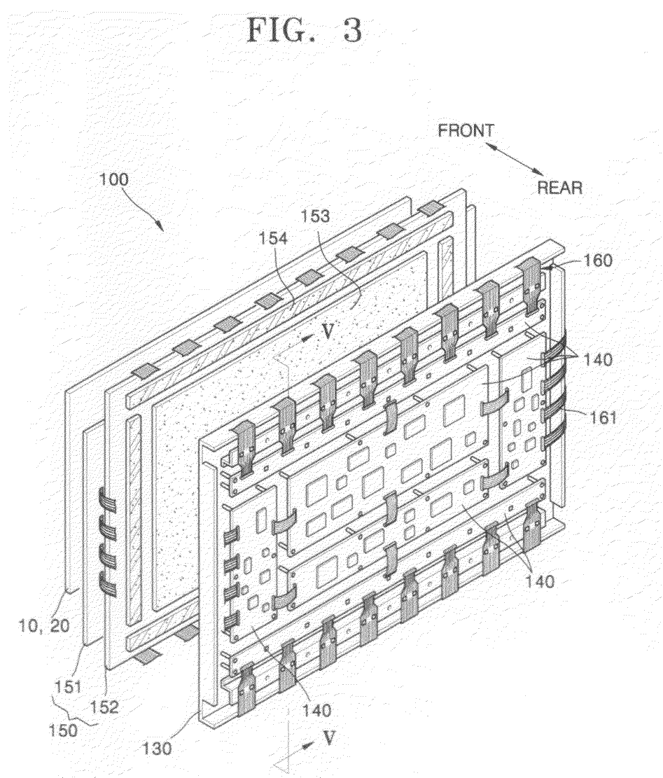

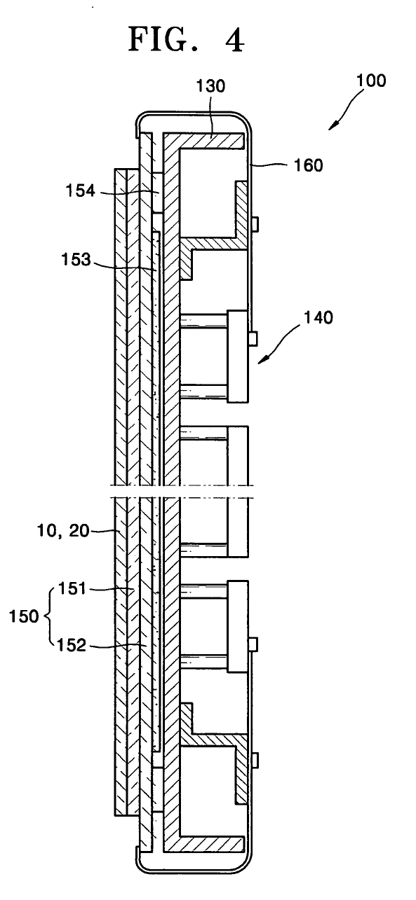

FIG. 3 illustrates a perspective view of a plasma display apparatus including a filter according to an embodiment of the present invention, and FIG. 4 illustrates a cross-sectional view along line V-V of the plasma display apparatus of FIG. 3.

Referring to FIGS. 3-4, the filters 10 and/or 20 may be used in a plasma display apparatus 100. It is noted, however, that a filter according to embodiments of the present invention may be used in any suitable display apparatus.

The plasma display apparatus 100 may include a plasma display panel (PDP) 150, a chassis 130, at least one thermally conductive member 153, and a circuit unit 140. The filter 10 or 20 may be attached to a front surface of the PDP 150.

The PDP 150 may include a front panel 151 and a rear panel 152. The front and rear panels 151 and 152 may be attached to each other with a predetermined space therebetween. A discharge gas may be sealed between the front and rear panels 151 and 152. Excitation of the discharge gas may trigger emission of visible light, so visible light may be emitted toward the front panel 151 to form images thereon.

The filter 10 or 20 may be attached to a front surface of the front panel 151, i.e., a surface facing away from the rear panel 152, by an adhesive layer (not shown). The filter 10 or 20 may transmit internal light, i.e., visible light emitted from the PDP 150 due to the gas discharge, while reflecting away or blocking external light, i.e., light emitted from a light source outside the plasma display apparatus 100. Accordingly, bright room contrast of the PDP 150 may improve. In addition, a substantially direct bonding of the filter 10 or 20 to the front surface of the PDP150 via the base film 13 or via the base film 13 with a single adhesive layer thereon may prevent or substantially minimize double image reflection. Further, the filter 10 or 20 may have a substantially lighter weight than the conventional filter, so manufacturing and distribution costs may be reduced.

The chassis 130 of the plasma display apparatus 100 may be disposed on a rear surface of the rear panel 152 of the PDP 150, i.e., a surface facing away from the front panel 151, to structurally support the PDP 150. The chassis 130 may be formed of a rigid material, such as metal, e.g., aluminum or iron, or plastic. The chassis 130 may be attached to the PDP 150 via an adhesive, e.g., double-side tapes 154. For example, a double-side tape 154 may be applied along edges of the rear surface of the rear panel 152, as illustrated in FIG. 3, to facilitate attachment of the chassis 130 to the PDP 150.

The thermally conductive member 153 may be interposed between the chassis 130 and the PDP 150 to dissipate heat from the PDP 150 through the chassis 130. For example, the thermally conductive member 153 may be attached to the rear surface of the rear panel 152, so the double-sided tapes 154 may be on the rear panel 152 around the thermally conductive member 153, as illustrated in FIG. 3. As such, upon attachment of the chassis 130 to the rear panel 152 via the double-sided tapes 154, the thermally conductive member 153 may be in close proximity to the chassis 130 to facilitate heat dissipation therethrough.

The circuit unit 140 may be disposed on a rear surface of the chassis 130, i.e., a surface facing away from the PDP 150. The circuit unit 140 may include a plurality of circuits to operate the PDP 150. The circuit unit 140 may transmit electrical signals to the PDP 150 by signal carrying means, e.g., a flexible printed cable (FPC), a tape carrier package (TCP), a chip on film (COF), or the like. For example, a plurality of FPCs 161 and TCPs 160 may be disposed along side edges of the chassis 130 to connect circuits of the circuit unit 140 to the PDP 150.

### EXAMPLES

### Example 1

A filter was prepared according to an embodiment of the present invention. The filter included a color pattern having a width w1 of 80 μm, a thickness t1 of 175 μm, and an interval d1 of 80 μm. Accordingly, the aperture rate was 50%.

### Comparative Example 1

A filter was prepared by sequentially stacking an anti-reflection layer, an etching copper (Cu) mesh film, a near infrared-absorbing layer, and a polyethylene terephthalate (PET) base film on top of each other with an adhesive layers therebetween. Coloring agents were added to the PET base film to adjust transmissivity of the filter, so transmissivity of the filter of Comparative Example 1 was equal to transmissivity of the filter of Example 1.

The filters of Example 1 and Comparative Example 1 were compared in terms of brightness and bright room contrast. Bright room contrast (BRC) was calculated according to Equation 1 below,

$$B R C = \frac{Peak + E L R B}{Minimum + E L R B} \approx \frac{Peak}{E L R B} \qquad Equation 1$$

where “Peak” refers to peak brightness of a display apparatus, “Minimum” refers to minimum brightness of a display apparatus, and “ELRB” refers to external light reflection brightness. Results are reported in Table 1 below.

TABLE 1

| | Transmissivity | Peak [cd/m²] | ELRB [cd/m²] | BRC |
|---|---|---|---|---|
| Example 1 | 39% | 546 | 1.370 | 398:1 |
| Comparative | 39% | 546 | 1.772 | 308:1 |
| Example 1 | | | | |

As illustrated in Table 1, despite a same transmissivity, the filter of Example 1, i.e., a filter according to embodiments of the present invention, exhibited lower external light reflection brightness than the filter of Comparative Example 1. Accordingly, the bright room contrast of a display including the filter of Example 1 was improved by about 23%.

A filter according to embodiments of the present invention may be advantageous in providing reduced weight due to decreased thickness of the base film therein, so manufactured costs may be reduced. Further, the filter may be directly bound to a front surface of a display apparatus, so reflection of double images may be prevented or substantially minimized. In addition, use of the filter in the display apparatus may improve bright room contrast of the display apparatus by transmitting internal light and blocking external light.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A filter, comprising:
a base film having a first surface and a second surface; and
a plurality of first color patterns on the first surface of the base film, the first color patterns having a stripe pattern with first predetermined intervals therebetween.

2. The filter as claimed in claim 1, wherein widths of the first color patterns and widths of the first predetermined intervals therebetween are related according to w≦d≦95w, where w denotes a width of a single color pattern of the plurality of first color patterns and d denotes a width of a single interval between two adjacent first color patterns.

3. The filter as claimed in claim 1, wherein a width of a single color pattern of the plurality of first color patterns is about 5 μm to about 50 μm.

4. The filter as claimed in claim 3, wherein a thickness of the first color patterns is about 1 μm to about 200 μm.

5. The filter as claimed in claim 4, wherein a ratio of the thickness to the width of the first color patterns is about 0.025 to about 50.

6. The filter as claimed in claim 1, further comprising an adhesive layer on a second surface of the base film.

7. The filter as claimed in claim 1, wherein the base film includes dyes and/or pigments.

8. The filter as claimed in claim 1, further comprising a plurality of second color patterns on the second surface of the base film, the second surface being opposite the first surface.

9. The filter as claimed in claim 8, wherein the second color patterns have a stripe pattern with second predetermined intervals therebetween.

10. The filter as claimed in claim 9, wherein the second color patterns overlap with the first color patterns.

11. The filter as claimed in claim 10, wherein the first color patterns overlap at least about 80% of the second color patterns.

12. The filter as claimed in claim 11, wherein the first and second color patterns completely overlap each other.

13. The filter as claimed in claim 9, wherein widths of the first and second color patterns and widths of the first and second predetermined intervals therebetween, respectively, are related according to w≦d≦95w, where w denotes a width of a single first or second color pattern and d denotes a width of a single interval between two adjacent first or second color patterns.

14. The filter as claimed in claim 9, wherein widths of the first color patterns substantially equal widths of the second color patterns.

15. The filter as claimed in claim 9, further comprising an adhesive layer on the second surface of the base film, the adhesive layer being in the second intervals between the second color patterns.

16. The filter as claimed in claim 8, wherein a width of each of the first and second color patterns is about 5 μm to about 60 μm.

17. The filter as claimed in claim 16, wherein a thickness of each of the first and second color patterns is about 1 μm to about 200 μm.

18. The filter as claimed in claim 17, wherein a ratio of the thickness to the width of each of the first and second color patterns is about 0.025 to about 60.

19. A display apparatus, comprising:
a display panel configured to display images;
an operation circuit configured to electrically control the display panel;
a chassis between the display panel and the operation circuit; and
a filter attached to a front surface of the display panel,
wherein the filter includes a base film having a first surface and a second surface, and a plurality of first color patterns on the first surface of the base film, the first color patterns having a stripe pattern with first predetermined intervals therebetween.

20. The display apparatus as claimed in claim 18, wherein the display apparatus is a plasma display apparatus.
